(19) United States
(12) Patent Application Publication
(10) Pub. No.: US 2007/0171189 A1
(43) Pub. Date: Jul. 26, 2007

(54) Auxiliary reading system of handheld electronic device

(75) Inventor: Chen-Ning Hsi, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/434,295

(22) Filed: May 15, 2006

(30) Foreign Application Priority Data
Jan. 20, 2006 (TW) 095102170

(51) Int. Cl. G09G 5/00

(52) U.S. Cl. 345/156

(57) ABSTRACT

A handheld electronic device having an auxiliary reading system for helping the user clearly understand what reading procedure is proceeding and make notes by themselves is provided. The auxiliary reading system of the handheld electronic device comprises a text generating program executed to perform a text decoration operation for successively generating text decorations when the user reads document files from the handheld electronic device. The text decorations are effective for guiding the user to read the document files and make notes.

### FIELD OF THE INVENTION

The present invention relates to a handheld electronic device, and more particularly to a handheld electronic device having an auxiliary reading system for helping the user clearly understand what reading procedure is proceeding and how to make notes.

### BACKGROUND OF THE INVENTION

Generally, when a handheld electronic device such as a mobile phone, a personal digital assistant (PDA) or a digital portable player is used, the user can look at the screen for realizing or controlling the operation of the handheld electronic device. Since the screen is small-sized, the user may fail to well understand the text contents contained in the short messages, the electronic books or the lyrics. In a case that the users distract their attention in a short while, they may forget which sentence or which paragraph has just been read. Therefore, it is important to design a handheld electronic device capable of helping the user clearly understand what reading procedure is proceeding.

Furthermore, although the conventional handheld electronic device has the function of showing the text contents of document files, the users fail to make notes or headnotes by themselves to record their opinions or incomprehensible contents. Therefore, it is also important to provide a handheld electronic device capable of helping the user make notes to the original document file when the text contents of the document file are read.

In views of the above-described disadvantages resulted from the prior art, the applicant keeps on carving unflaggingly to develop a handheld electronic device having an auxiliary reading system according to the present invention through wholehearted experience and research.

### SUMMARY OF THE INVENTION

It is an object of the present invention to provide a handheld electronic device having an auxiliary reading system for helping the user clearly understand what reading procedure is proceeding.

It is another object of the present invention to provide a handheld electronic device having an auxiliary reading system for helping the user make notes by themselves so as to record their opinions or incomprehensible contents when the text contents of the document file are read.

In accordance to an aspect of the present invention, there is provided an auxiliary reading system of a handheld electronic device. By the handheld electronic device, a document file is converted into at least an image frame to be displayed on a screen. The auxiliary reading system of the handheld electronic device comprises a text generating program. In response to a first operating instruction inputted into the handheld electronic device, the text generating program is executed to perform a first text decoration operation for successively generating first text decorations of the texts contained in the image frame.

In accordance to another aspect of the present invention, there is provided a handheld electronic device permissible to convert a document file into at least an image frame to be displayed on a screen. The handheld electronic device comprises an auxiliary reading system. In response to a first operating instruction inputted into the handheld electronic device, the auxiliary reading system performs a first text decoration operation for successively generating first text decorations of the texts contained in the image frame.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram of a handheld electronic device having an auxiliary reading system according to a preferred embodiment of the present invention;

FIGS. 2A˜2H are schematic diagrams illustrating a mobile phone using the auxiliary reading system for guiding the user to read short messages and make notes; and

FIG. 3 is a schematic diagram illustrating the contents of a short message including the notes made by the user and intended to be forwarded to other receivers.

### DETAILED DESCRIPTION OF THE PREFERRED EMBODIMENT

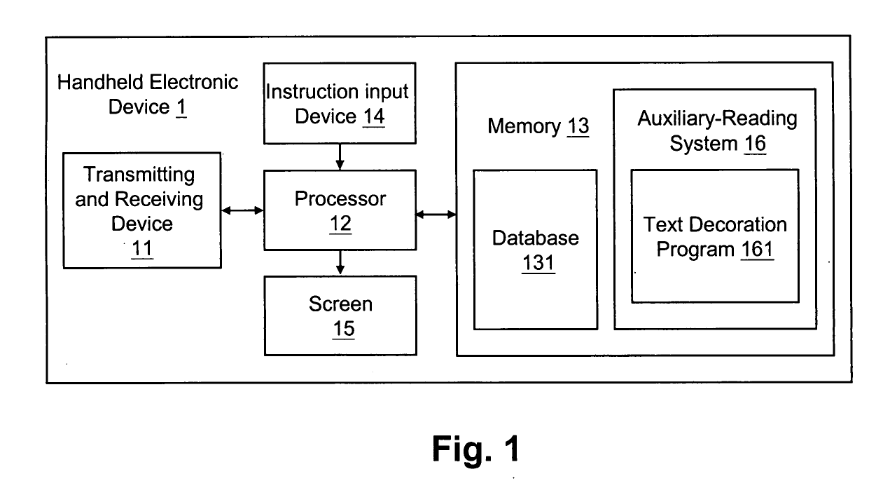

Referring to FIG. 1, a schematic circuit block diagram of a handheld electronic device having an auxiliary reading system according to a preferred embodiment of the present invention is illustrated. The handheld electronic device 1 of FIG. 1 comprises a transmitting and receiving device 11, a processor 12, a memory 13, an instruction input device 14, a screen 15 and an auxiliary reading system 16. The programs previously stored in the memory 13 may be executed by the processor 12 so as to perform associated data computations, systematic control operations and text file conversions. The processed images are then displayed on the screen. An exemplary memory 13 used in the handheld electronic device 1 includes for example a read-only memory (ROM), a random-access memory (DRAM) or a combo-memory.

The transmitting and receiving device 11 as shown in FIG. 1 is for example a wireless communication module or a transmission interface for transmitting and receiving document files therevia. For example, in a case that the handheld electronic device 1 is a mobile phone, the transmitting and receiving device 11 is a wireless communication module for transmitting and receiving short messages or a transmission line for transmitting and receiving document files. The instruction input device 14 of the handheld electronic device 1 is built as an internal part of the handheld electronic device 1. An exemplary instruction input device 14 includes a key, a rotary wheel (or a rotary disc) or a microphone. In response to a user's action such as a pressing action, a stirring action or the generation of a sound, an instruction is inputted to the handheld electronic device 1 via the instruction input device 14.

The program which has been previously stored in the memory 13 is a text generating program. By the text generating program, the document files received by the handheld electronic device 1 or have been previously stored in the database 131 of the memory 13 are converted into one or more image frames and successively displayed on the screen 15.

In the handheld electronic device 1 as shown in FIG. 1, the auxiliary reading system 16 comprises a text decoration program 161. After the document files received by the handheld electronic device 1 are converted into one or more image frames and displayed on the screen 15, the text decoration program 161 will successively generate various decorations of the texts contained in the image frames in response to an operating instruction inputted via the instruction input device 14 of the handheld electronic device 1. The prompts of the text decorations are helpful for guiding the user to read through the whole document files. The operations of generating text decorations include generation of highlight texts, generation of bold-faced texts, variations of text colors, variations of text sizes or addition of underlines.

Hereinafter, some embodiments of using the auxiliary reading system 16 of the handheld electronic device 1 for facilitating a user to read the text contents of the document files according to the present invention will be illustrated as follows.

In a first preferred embodiment, a first operating instruction is inputted into the handheld electronic device 1 via the instruction input device 14, for example a specified key of the handheld electronic device 1 is once pressed down. In response to the first operating instruction, the text decoration program 161 of the auxiliary reading system 16 will successively generate various decorations of the texts contained in the image frames. After a second operating instruction is inputted into the handheld electronic device 1 via the instruction input device 14, for example the specified key of the handheld electronic device 1 is pressed down again, the text decoration program 161 of the auxiliary reading system 16 is disabled and thus the generation of the text decorations is terminated. Likewise, in response to a third operating instruction inputted into the handheld electronic device 1 via the instruction input device 14 (for example, the specified key of the handheld electronic device 1 is pressed down again), the text decoration program 161 of the auxiliary reading system 16 will continuously generate various decorations of the texts. Accordingly, the auxiliary reading system 16 of the handheld electronic device 1 is capable of facilitating the user to read or pause reading the text contents in an interactive manner.

In a second preferred embodiment, a first operating instruction is continuously inputted into the handheld electronic device 1 via the instruction input device 14, for example a specified key of the handheld electronic device 1 is continuously pressed down. In response to the first operating instruction, the text decoration program 161 of the auxiliary reading system 16 will successively generate various decorations of the texts contained in the image frames. If the user stops inputting the first operating instruction into the handheld electronic device 1 via the instruction input device 14, for example the operation of pressing down the specified key of the handheld electronic device 1 is stopped, the text decoration program 161 of the auxiliary reading system 16 is disabled and thus the generation of the text decorations is terminated. Likewise, in response to a second operating instruction continuously inputted into the handheld electronic device 1 via the instruction input device 14 (for example, the specified key of the handheld electronic device 1 is pressed down again), the text decoration program 161 of the auxiliary reading system 16 will successively generate various decorations of the texts. Accordingly, the speed or the scheduled progress of generating the text decorations when the users read the whole document files can be determined according to the users' requirement.

In a third preferred embodiment of the handheld electronic device 1, various decorations of the texts are successively generated to facilitate the user to manipulate the reading scheduled progress. In addition, during the reading process, various decorations of the texts associated with certain paragraphs, certain sentences or certain single characters can be added to the original document file, so that the users may make notes or headnotes by themselves. For example, in a case that a user has some ideas or doubts about certain paragraph, sentence or single character when reading a document file, or in another case the user intends to put emphasis on certain paragraph, sentence or single character, a first operating instruction may be inputted into the handheld electronic device 1 via the instruction input device 14. In response to the first operating instruction, the text decoration program 161 of the auxiliary reading system 16 will successively generate various decorations of the texts contained in the image frames, and the text decorations will be stored in the original document file. Alternatively, other types of text decorations will be created to be displayed on the image frame along with the current text decorations, and then the newly created text decorations are also stored in the original document file. These two approaches are effective for making notes. When the user intends to stop making notes, a second operating instruction may be inputted into the handheld electronic device 1 via the instruction input device 14. In response to the second operating instruction, the text decoration program 161 of the auxiliary reading system 16 will stop storing the text decorations into the document file, or stop creating new text decorations and storing the new text decorations into the document file. In particular, the text decorations made by the users themselves and used as notes are not disappeared after the whole document file has been read. Instead, the text decorations are added to the original document file and stored into the handheld electronic device 1 as a new document file.

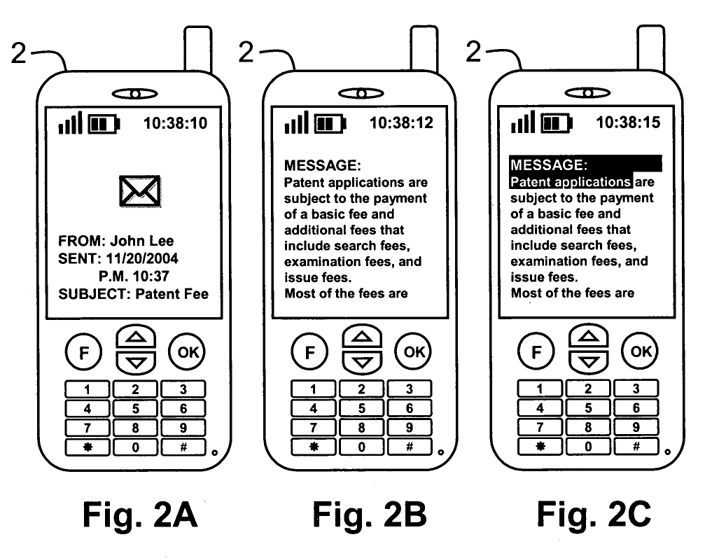

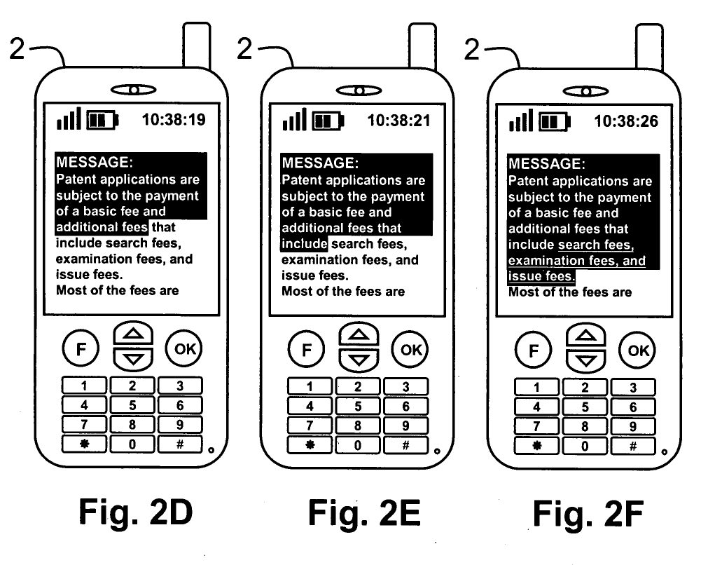

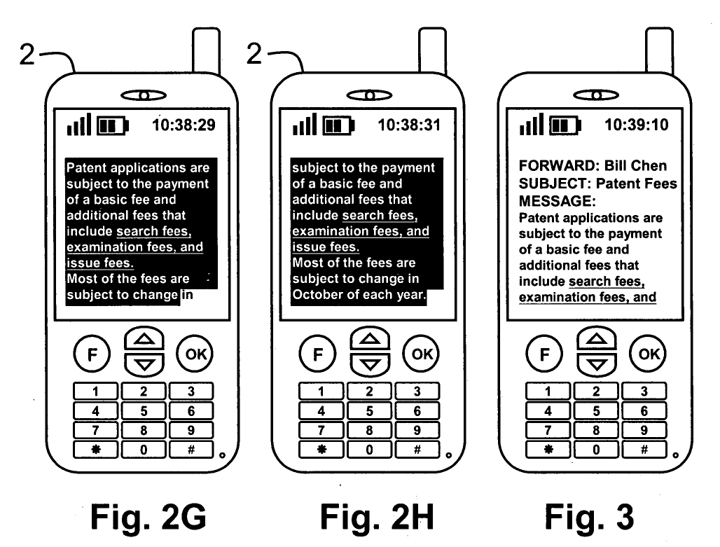

Hereinafter, an embodiment of an auxiliary reading system of a handheld electronic device and the operation of the auxiliary reading system for facilitating a user to understand what reading procedure is proceeding and how to make notes according to the present invention will be illustrated with reference to FIGS. 2A˜2H. In this embodiment, an exemplified handheld electronic device is a mobile phone 2.

As shown in FIG. 2A, a short message is received. Then, in response to an instruction inputted via the instruction input unit, for example upon a specific key (e.g. the OK key) of the mobile phone 2 is once pressed down, the text file associated with the short message will be converted into image frames to be shown on the screen, as is shown in FIG. 2B. For a purpose of automatically broadcasting this short message to read the contents of the short message, another specific key (e.g. the “∇” key) is once pressed down, and thus the highlight texts as shown in FIGS. 2C, 2D, 2E, 2F, 2G and 2H are successively generated. These highlight texts are effective for guiding the user to read the short message. If the user intends to pause or stop reading the short message, the user may press down the pressed down the “∇” key of the mobile phone 2 once again so as to terminate generation of the text decorations. Likewise, if the “∇” key of the mobile phone 2 is pressed once again, the highlight texts will be successively generated. Accordingly, by creating highlight texts, the auxiliary reading system of the mobile phone 2 is capable of facilitating the user to read or pause reading the text contents in an interactive manner.

Furthermore, the speed of reading the short message can be determined according to the users' requirement. For example, if the user continuously presses down the “∇” key of the mobile phone 2, the highlight texts as shown in FIGS. 2C˜2H are successively generated for guiding the user to read the short message. If the user stops pressing down the “∇” key, the operations of generating the highlight texts are terminated. The highlight texts will be successively generated when the “∇” key of the mobile phone 2 is pressed down again. Accordingly, the speed or the scheduled progress of generating the highlight texts when the users read the whole short message can be determined according to the users' requirement.

Furthermore, during the reading process, various decorations of the texts associated with a certain paragraph or sentence can be added to the short message. As shown in FIG. 2E, during the user read the contents of the short message, if the user intends to add text decorations to a certain sentence, the user may press down the “∇” key of the mobile phone 2 once or otherwise continuously press down the “∇” key, thereby adding underlines as headnotes. The underlines and the original highlight texts are simultaneously displayed on the image frame and the newly created text decorations (i.e. the underlines) are then stored in the short message. When the user intends to stop making notes, the user may press down the “∇” key once again or otherwise stop pressing down the “∇” key so as to terminate generation of the underlines and stop storing the text decorations into the document file, as can be seen in FIG. 2F. In particular, the underlines made by the users themselves and used as notes are not disappeared after the whole short message has been read. Instead, the text decorations are added to the short message and stored into the mobile phone 2 as a new document file. Under this circumstance, the user will quickly realize the key points of the short message if this short message is read again. In addition, as shown in FIG. 3, if the short message including the notes made by the user is forwarded to other receivers, the receivers may easily realize which paragraph or sentence is emphasized by the user.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An auxiliary reading system of a handheld electronic device, a document file being converting into at least an image frame by said handheld electronic device to be displayed on a screen, said auxiliary reading system of said handheld electronic device comprising a text generating program executed to perform a first text decoration operation for successively generating a first text decoration of the texts contained in said image frame in response to a first operating instruction inputted into said handheld electronic device.

2. The auxiliary reading system of said handheld electronic device according to claim 1 wherein said text generating program stops generating said first text decoration when said first operating instruction is interrupted.

3. The auxiliary reading system of said handheld electronic device according to claim 1 wherein said text generating program further stores said first text decoration into said document file in response to a second operating instruction inputted into said handheld electronic device, and stops storing said first text decoration into said document file in response to a third operating instruction inputted into said handheld electronic device.

4. The auxiliary reading system of said handheld electronic device according to claim 1 wherein said text generating program stops generating said first text decorations in response to a second operating instruction inputted into said handheld electronic device.

5. The auxiliary reading system of said handheld electronic device according to claim 1 further comprising an instruction input device for inputting operating instructions therevia.

6. The auxiliary reading system of said handheld electronic device according to claim 5 wherein said instruction input device is a key.

7. The auxiliary reading system of said handheld electronic device according to claim 5 wherein said instruction input device is a rotary wheel.

8. The auxiliary reading system of said handheld electronic device according to claim 5 wherein said instruction input device is a microphone.

9. The auxiliary reading system of said handheld electronic device according to claim 1 wherein said first text decoration operation includes generation of highlight texts associated with the texts contained in said image frame.

10. The auxiliary reading system of said handheld electronic device according to claim 1 wherein said first text decoration operation includes generation of bold-faced texts associated with the texts contained in said image frame.

11. The auxiliary reading system of said handheld electronic device according to claim 1 wherein said first text decoration operation includes variations of text colors associated with the texts contained in said image frame.

12. The auxiliary reading system of said handheld electronic device according to claim 1 wherein said first text decoration operation includes variations of text sizes associated with the texts contained in said image frame.

13. The auxiliary reading system of said handheld electronic device according to claim 1 wherein said first text decoration operation includes addition of underlines associated with the texts contained in said image frame.

14. The auxiliary reading system of said handheld electronic device according to claim 1 wherein said text generating program further performs a second text decoration operation for successively generating second text decorations and stores said second text decorations into said document file in response to a second operating instruction inputted into said handheld electronic device, and stops storing said second text decorations into said document file in response to a third operating instruction inputted into said handheld electronic device.

15. The auxiliary reading system of said handheld electronic device according to claim 14 wherein said second text decoration operation includes generation of highlight texts associated with the texts contained in said image frame.

16. The auxiliary reading system of said handheld electronic device according to claim 14 wherein said second text decoration operation includes generation of bold-faced texts associated with the texts contained in said image frame.

17. The auxiliary reading system of said handheld electronic device according to claim 14 wherein said second text decoration operation includes variations of text colors associated with the texts contained in said image frame.

18. The auxiliary reading system of said handheld electronic device according to claim 14 wherein said second text decoration operation includes variations of text sizes associated with the texts contained in said image frame.

19. The auxiliary reading system of said handheld electronic device according to claim 14 wherein said second text decoration operation includes addition of underlines associated with the texts contained in said image frame.

20. A handheld electronic device permissible to convert a document file into at least an image frame to be displayed on a screen, said handheld electronic device comprising an auxiliary reading system performing a first text decoration operation for successively generating a first text decoration of the texts contained in said image frame in response to a first operating instruction inputted into said handheld electronic device.

21. The handheld electronic device according to claim 20 wherein said auxiliary reading system stops generating said first text decoration when said first operating instruction is interrupted.

22. The handheld electronic device according to claim 20 wherein said auxiliary reading system further stores said first text decorations into said document file in response to a second operating instruction inputted into said handheld electronic device, and stops storing said first text decorations into said document file in response to a third operating instruction inputted into said handheld electronic device.

23. The handheld electronic device according to claim 20 wherein said auxiliary reading system stops generating said first text decorations in response to a second operating instruction inputted into said handheld electronic device.

24. The handheld electronic device according to claim 20 further comprising an instruction input device for inputting operating instructions therevia.

25. The handheld electronic device according to claim 24 wherein said instruction input device is a key.

26. The handheld electronic device according to claim 24 wherein said instruction input device is a rotary wheel.

27. The handheld electronic device according to claim 24 wherein said instruction input device is a microphone.

28. The handheld electronic device according to claim 20 wherein said first text decoration operation includes generation of highlight texts associated with the texts contained in said image frame.

29. The handheld electronic device according to claim 20 wherein said first text decoration operation includes generation of bold-faced texts associated with the texts contained in said image frame.

30. The handheld electronic device according to claim 20 wherein said first text decoration operation includes variations of text colors associated with the texts contained in said image frame.

31. The handheld electronic device according to claim 20 wherein said first text decoration operation includes variations of text sizes associated with the texts contained in said image frame.

32. The handheld electronic device according to claim 20 wherein said first text decoration operation includes addition of underlines associated with the texts contained in said image frame.

33. The handheld electronic device according to claim 20 wherein said auxiliary reading system further performs a second text decoration operation for successively generating second text decorations and stores said second text decorations into said document file in response to a second operating instruction inputted into said handheld electronic device, and stops storing said second text decorations into said document file in response to a third operating instruction inputted into said handheld electronic device.

34. The handheld electronic device according to claim 33 wherein said second text decoration operation includes generation of highlight texts associated with the texts contained in said image frame.

35. The handheld electronic device according to claim 33 wherein said second text decoration operation includes generation of bold-faced texts associated with the texts contained in said image frame.

36. The handheld electronic device according to claim 33 wherein said second text decoration operation includes variations of text colors associated with the texts contained in said image frame.

37. The handheld electronic device according to claim 33 wherein said second text decoration operation includes variations of text sizes associated with the texts contained in said image frame.

38. The handheld electronic device according to claim 33 wherein said second text decoration operation includes addition of underlines associated with the texts contained in said image frame.
